(19) United States
(12) Patent Application Publication
(10) Pub. No.: US 2021/0319478 A1
(43) Pub. Date: Oct. 14, 2021

(54) Automatic Cloud, Hybrid, and Quantum-Based Optimization Techniques for Communication Channels

(71) Applicant: CloudNCo, Inc. dba NextUser, San Francisco, CA (US)

(72) Inventor: Matthieu Dejardins, San Francisco, CA (US)

(21) Appl. No.: 17/354,974

(22) Filed: Jun. 22, 2021

Related U.S. Application Data
(63) Continuation-in-part of application No. 17/180,166, filed on Feb. 19, 2021.
Application No. 17/180,166 is a continuation-in-part of application No. 14/276,971, filed on May 13, 2014, now abandoned.

(51) Int. Cl. G06Q 30/02; H04B 10/70; G06T 19/00

(52) U.S. Cl. CPC G06Q 30/0271; G06T 19/006; H04B 10/70

(57) ABSTRACT

Provided are methods and systems for optimization and personalization of marketing actions using cloud, hybrid, and quantum-based computing techniques. An example method commences with iteratively selecting, from a pool of prospective clients, at least one subgroup of the prospective clients based on predetermined criteria. The method further includes performing at least one marketing action on the at least one subgroup of the prospective clients. The method then continues with receiving a feedback from a prospective client belonging to the at least one subgroup of the prospective clients in response to the at least one marketing action. The method further includes scoring, by a machine learning technique, the feedback received from the prospective client. The method further includes modifying the at least one marketing action until the at least one marketing action is optimized for the prospective client based on the scoring of the feedback.

### CROSS REFERENCE TO RELATED APPLICATIONS

The present application is a continuation-in-part of U.S. application Ser. No. 17/180,166, filed on Feb. 19, 2021 and titled “Platform for Optimization and Personalization of Existing Communication Channels,” which is, in turn, a continuation-in-part of U.S. application Ser. No. 14/276,971, filed on May 13, 2014 and titled “Delivering Personalized User Experiences via an Array of Channels Based on Collected User Data and Customizable Business Rules,” the subject matter of which are incorporated herein by reference for all purposes.

### TECHNICAL FIELD

This application relates generally to data processing and, more specifically, to optimization and personalization of communication channels using cloud, hybrid, and quantum-based computing techniques.

### BACKGROUND

The approaches described in this section could be pursued but are not necessarily approaches that have been previously conceived or pursued. Therefore, unless otherwise indicated herein, the approaches described in this section are not prior art to the claims in this application and are not admitted to be prior art by inclusion in this section.

Conventional approaches to communicating messages to prospective customers rely on the belief that exercising constant messaging pressure on customers increases likelihood of buying. However, sending irrelevant marketing messages does not necessarily increase the likelihood of convincing a prospective customer considering the content is not engaging the prospective customer personally. Oftentimes, it just creates unnecessary solicitation on customers and can lead to ignoring the received communications by customers. Moreover, conventionally automated and marketing messages are sent to customers in a predefined and sequential way. However, these siloed communications are not customized to target individual customers based on their specific user profile, location, weather, interests, habits, etc.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an example embodiment, a system for optimization and personalization of marketing actions using cloud, hybrid, and quantum-based computing techniques is provided. The system may include an optimization and personalization engine and a data aggregation module. The optimization and personalization engine may be configured to iteratively select, from a pool of prospective clients, at least one subgroup of the prospective clients based on predetermined criteria. The optimization and personalization engine may be further configured to perform at least one marketing action on the at least one subgroup of the prospective clients. The optimization and personalization engine may be configured to receive a feedback from a prospective client belonging to the at least one subgroup of the prospective clients. The feedback may be received in response to the at least one marketing action. The data aggregation module may be configured to score, by a machine learning technique, the feedback received from the prospective client. The optimization and personalization engine may be configured to modify the at least one marketing action until the at least one marketing action is optimized for the prospective client. The modification may be performed based on scoring of the feedback.

According to another embodiment, a method for optimization and personalization of marketing actions using cloud, hybrid, and quantum-based computing techniques is provided. The method may commence with iteratively selecting, from a pool of prospective clients, at least one subgroup of the prospective clients based on predetermined criteria. The method may further include performing at least one marketing action on the at least one subgroup of the prospective clients. The method may then continue with receiving a feedback from a prospective client belonging to the at least one subgroup of the prospective clients in response to the at least one marketing action. The method may also include scoring, by a machine learning technique, the feedback received from the prospective client. The method may further include modifying the at least one marketing action based on the scoring of the feedback until the at least one marketing action is optimized for the prospective client.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 is a block diagram of an environment, in which systems and methods for optimization and personalization of marketing actions using cloud, hybrid, and quantum-based computing techniques can be implemented, according to some example embodiments.

FIG. 2 is a high-level block diagram illustrating an architecture within which elements of a system for optimization and personalization of marketing actions using cloud, hybrid, and quantum-based computing techniques can be implemented, according to an example embodiment.

FIG. 3 is a flow diagram that shows a method for optimization and personalization of marketing actions using cloud, hybrid, and quantum-based computing techniques, according to an example embodiment.

FIG. 4 is a schematic diagram illustrating how a system for optimization and personalization of marketing actions works with existing marketing applications and using cloud, hybrid, and quantum-based computing techniques, according to an example embodiment.

FIG. 5 is a summary diagram showing a plurality of communication channels managed by an optimization and personalization engine, according to an example embodiment.

FIG. 6 is a schematic diagram illustrating generating self-optimizing content by a system for optimization and personalization of marketing actions using cloud, hybrid, and quantum-based computing techniques, according to an example embodiment.

FIG. 7 is a schematic diagram illustrating an advanced testing of a population by a system for optimization and personalization of marketing actions using cloud, hybrid, and quantum-based computing techniques, according to an example embodiment.

FIG. 8 is a schematic diagram illustrating selecting a multi-sequential marketing scenario by a system for optimization and personalization of marketing actions using cloud, hybrid, and quantum-based computing techniques, according to an example embodiment.

FIG. 9 is an example diagram demonstrating creating a multi-sequential marketing scenario online or offline by a system for optimization and personalization of marketing actions using cloud, hybrid, and quantum-based computing techniques, according to an example embodiment.

FIG. 10 is a schematic diagram illustrating determining a state of mind of a prospective customer by a system for optimization and personalization of marketing actions using cloud, hybrid, and quantum-based computing techniques, according to an example embodiment.

FIG. 11 is a schematic diagram illustrating performing contextual personalization by a system for optimization and personalization of marketing actions using cloud, hybrid, and quantum-based computing techniques, according to an example embodiment.

FIG. 12 is a schematic diagram illustrating inferring psychographic data by a system for optimization and personalization of marketing actions using cloud, hybrid, and quantum-based computing techniques, according to an example embodiment.

FIG. 13 is a schematic diagram illustrating a multi-factor personality model developed based on psychographic data associated with a user.

FIG. 14 illustrates a schematic diagram of a quantum Internet used by a system for optimization and personalization of marketing actions using cloud, hybrid, and quantum-based computing techniques, according to an example embodiment.

FIG. 15 is a schematic diagram combining six principles used by a system for optimization and personalization of marketing actions using cloud, hybrid, and quantum-based computing techniques.

FIG. 16 shows schematic diagrams illustrating a content-driven example use case of a system for optimization and personalization of marketing actions using cloud, hybrid, and quantum-based computing techniques.

FIG. 17 shows schematic diagrams illustrating a psychographic-driven example use case of a system for optimization and personalization of marketing actions using cloud, hybrid, and quantum-based computing techniques.

FIG. 18 shows a diagrammatic representation of a quantum processing unit configured to perform any one or more of the methodologies discussed herein.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present disclosure provides systems and methods for optimization and personalization of marketing actions using cloud, hybrid, and quantum-based computing techniques. The disclosed systems and methods can be used by companies, brands, and product and service providers to personalize content that can be delivered to their users across a plurality of existing communication channels.

The cloud, hybrid, and quantum-based optimization of communication channels allows gathering data about prospective customers and anticipating wishes and needs of prospective customers to provide the customers with the most relevant marketing content. Communication strategy adapted to each customer using cloud, hybrid, and quantum-based computing techniques maximizes probability of interaction of customers with the content. Specifically, the cloud, hybrid, and quantum-based computing techniques used by the systems and methods of the present disclosure ensure targeting the right person with the right message at the right time.

The cloud, hybrid, and quantum-based computing techniques are based on quantum physics. A quantum computer is a device that performs quantum computations based on the exploitation of collective properties of quantum states, namely superposition and entanglement. In the quantum computing, a qubit (also referred to a quantum bit) is the unit of quantum information. The quantum computing uses quantum mechanics to perform operations. The data unit (qubit) used in quantum computing has two main proprieties (superposition and entanglement). Qubits have a complex structure and can hold a lot of information and process the information at the same time. As a consequence, quantum computers can execute complex algorithms classical computer were not able to execute. The quantum computers calculate faster than classical computers and are also able to deal with all type of calculations. Despite recent advances in the fields of quantum hardware and software, fault-tolerant quantum computers (FTQCs) capable of performing general-purpose tasks are unlikely to replace classical computers anytime soon. In the near term, noisy intermediate-scale quantum (NISQ) computers will be capable of deriving probabilistic solutions from imperfect qubits. Hybrid quantum-classical techniques have also shown promise, whereby classical computers delegate certain tasks to purpose-built quantum devices within the same workflow.

Example quantum computers (also referred to as quantum processing units) include the quantum Turing machine, quantum circuit model, one-way quantum computer, adiabatic quantum computer, quantum cellular automata, hybrid-quantum techniques such as noise intermediate-scale quantum (NISQ) and so forth.

Classical computers use bits (0 or 1) to store and process information. Quantum computers use qubits (linear combination of 0 and 1). As a consequence, quantum computers get the advantage with two main proprieties, namely superposition and entanglement, which are reasons why quantum physics is so powerful. The entanglement is a physical phenomenon according to which qubits have quantum states depending on each other regardless of the distance that separates them. The superposition is an ability of a quantum system to be in multiple states at the same time.

Quantum computing is the strategic technology, on which countries and companies are competing to possess it. In this race on quantum computer, two main words depict the advances of these key players: quantum supremacy and quantum advantage. Quantum supremacy means that a quantum computer can execute programs that all supercomputers of the world cannot execute. Quantum advantage means that quantum computer executes a program faster than a supercomputer.

There are two types of quantum software: software running quantum algorithms (quantum software development kits and computational platforms provide solutions for end-users, these help end users develop and test their quantum algorithms) and software enabling quantum computers to perform computations (quantum computers have performance issues due to random errors and error-correcting software is built to correct such errors). An error-correcting software or firmware is a low-level program that increases the stability of quantum computers. Among them three main things are available: a quantum software development kit, cloud services with platforms (computational platforms), quantum error-correcting software and firmware. Cloud-based quantum computing gives access to quantum emulators, simulators or processors through the cloud. Software development kit allows accessing a quantum virtual machine, with specific library that provides tools for creating and manipulating quantum programs and running them on prototype quantum devices or on simulators on a local computer.

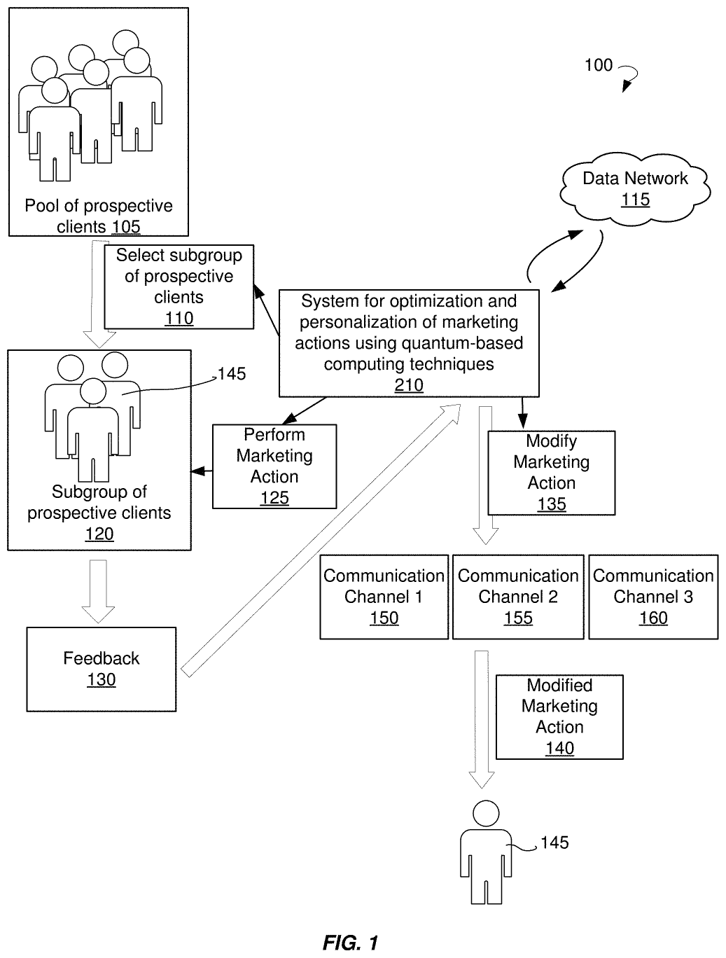

Referring now to the drawings, FIG. 1 is a block diagram of environment 100, in which systems and methods for optimization and personalization of marketing actions using cloud, hybrid, and quantum-based computing techniques can be implemented, according to some example embodiments. The environment 100 may include a system 210 for optimization and personalization of marketing actions using cloud, hybrid, and quantum-based computing techniques, a pool of prospective clients 105, communication channels 150, 155, and 160, and a data network 115.

The system 210 can be connected to the data network 115 and may have access to a pool of prospective clients 105. The system 210 may be configured to select a subgroup 120 of prospective clients in block 110. The system 210 can perform a marketing action in block 125 on the subgroup 120 of prospective clients. In response to the marketing action, the system 210 can receive a feedback 130 from a prospective client 145 belonging to the subgroup 120 of the prospective clients. After receiving the feedback 130, the system 210 can modify the marketing action in block 135 to optimize the marketing action for the prospective client 145. Upon modification of the marketing action, the system 210 may perform a modified marketing action 140 via one or more communication channels 150, 155, and 160 with respect to the prospective client 145.

The system 210 may access the communication channels 150, 155, 160 via the data network 115. The data network 115 may include the Internet, a cloud network, or any other network capable of communicating data between devices. Suitable networks may include or interface with any one or more of, for instance, a local intranet, a corporate data network, a data center network, a home data network, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 115 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital, or analog interface or connection, mesh, or Digi® networking.

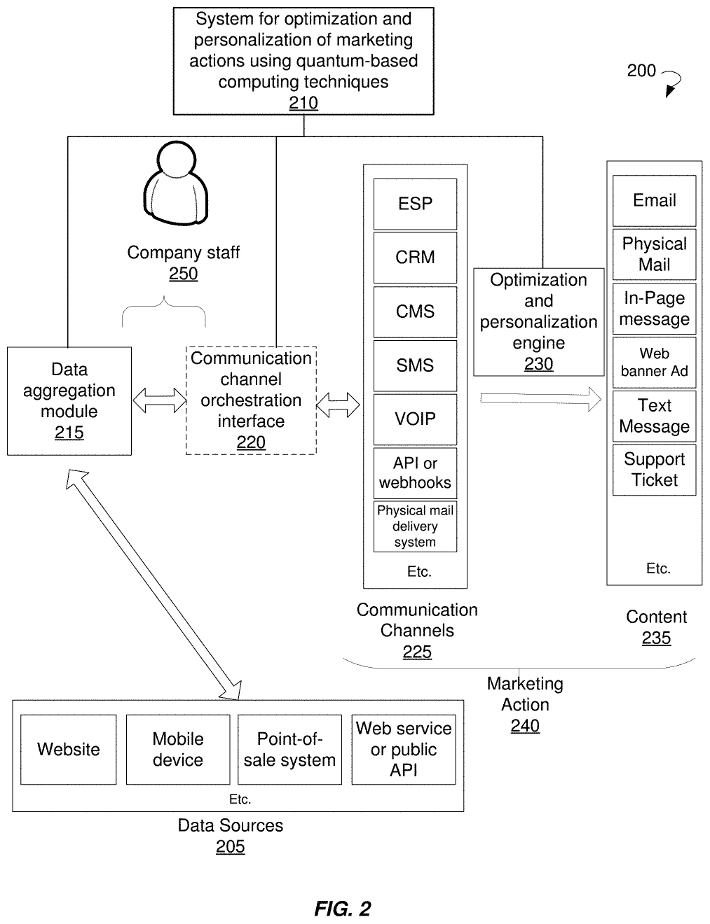

FIG. 2 illustrates a high-level block diagram of an architecture 200 within which elements of a system 210 for optimization and personalization of marketing actions using cloud, hybrid, and quantum-based computing techniques can be implemented. The system 210 may include a data aggregation module 215, an optimization and personalization engine 230, and, optionally, a communication channel orchestration interface 220.

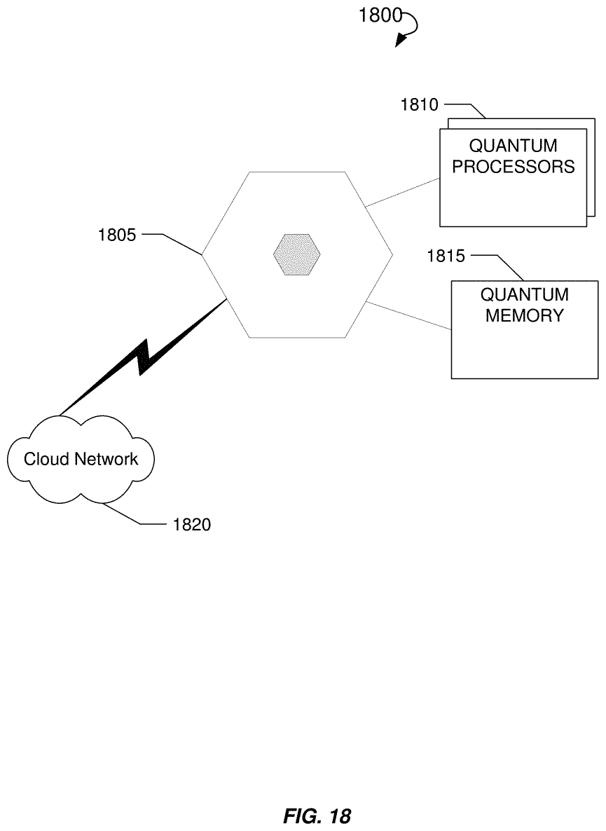

Each of the data aggregation module 215, the communication channel orchestration interface 220, and the optimization and personalization engine 230 may include a processor and a memory in communication with the processor and storing instructions executable by the processor. A system within which a set of instructions may be implemented is described in more detail below with reference to FIG. 18.

The optimization and personalization engine 230 may be configured to iteratively select, from a pool of prospective clients, at least one subgroup of the prospective clients based on predetermined criteria. The optimization and personalization engine 230 may be further configured to perform at least one marketing action on the at least one subgroup of the prospective clients. The at least one marketing action may be communicated to a user device associated with the prospective client. In an example embodiment, the user device may be a wearable device.

The user device may be configured to perform operations associated with one or more of the following techniques: artificial intelligence (AI), augmented reality (AR)/virtual reality (VR), rendering of three-dimensional (3D) objects, a telecommunication standard such as 5G and Internet of Things (IoT), and so forth. In an example embodiment, the AR/VR may provide one or more of the following features overlaid over physical objects: map directions, client assistance, visualization of marketing messages, promotions, real-time product recommendations, real-time content recommendations, and so forth.

The optimization and personalization engine 230 may be further configured to receive, in response to the at least one marketing action, a feedback from a prospective client belonging to the at least one subgroup of the prospective clients. The data aggregation module 215 may be configured to score, by a machine learning technique, the feedback received from the prospective client. The optimization and personalization engine 230 may be further configured to modify the at least one marketing action until the at least one marketing action is optimized for the prospective client. The modification of the at least one marketing action may be performed based on scoring of the feedback.

In some example embodiments, performing the at least one marketing action may include delivering content to the at least one subgroup of the prospective clients. The content may be templatized to create personalized communication messages for a plurality of communication channels. In an example embodiment, the at least one marketing action may be part of a multi-sequential marketing scenario personalized for the prospective client. In an example embodiment, the prospective client may be recognized using biometric recognition techniques.

In some example embodiments, the optimization of the at least one marketing action may be performed based on an evaluation of a state of mind of the prospective client. In a further example embodiment, the at least one marketing action may be optimized based on personal data and environmental data associated with the prospective client. The personal data may include one or more of the following: a body type, a skin color, a weight, a height, an agenda, preferences, declarative information, historical purchase data, historical behavior data, account information of, purchase history, third party data, contextual data, mobile application data, and so forth. The environmental data may include one or more of the following: weather, pollution, ultraviolet radiation, a location, and so forth.

In some example embodiment, the at least one marketing action may be optimized based on psychographic data. The psychographic data may include one or more of the following: social pressures and personality influencing customer behavior, client maturity, preferences of family members associated with the prospective client, interests, hobbies, emotional triggers, lifestyles, activities, opinions, personality traits, a health condition, implied needs, expressed needs, nutrition, habits, and so forth. The psychographic data may use a visual recognition to infer personality traits and assess sentiment.

The at least one marketing action may be optimized separately for each communication channel. The plurality of communication channels may include one or more of the following: a website, a mobile application, an email, a Short Message Service (SMS), a push notification, a customer support ticket, printed mail, and so forth.

In an example embodiment, the data aggregation module 215 may be further configured to collect and aggregate user data from at least one of data sources 205 and generate and maintain end user profiles, which may store all collected and aggregated user data. A vast array of user data associated with a user (also referred to as a prospective client) can be generated or received from a plurality of data sources. In an illustrative embodiment, the received data can include any combination of the following: an Internet Protocol (IP) address, data from user profiles on social networks or other websites, data associated with a location of a user, data obtained from sensors or in other ways from such things as offline stores, kiosks, mobile devices, or point-of-sale systems, data obtained via web services or application programming interfaces (APIs), web hooks, and so on.

Additionally, data associated with users can be generated, for instance, by combining, filtering, or processing the received data in a variety of ways. These ways can include using database retrieval, table lookups, machine learning, and cognitive computing; or augmenting the user data in other ways, such as via publicly available web services or APIs.

To convey a clearer sense of the multitude kinds of data that can be received or generated, it can be useful to classify some of example types of data associated with a user that can be received or generated in accordance with a predetermined taxonomy. Identity data may include data that can be used to distinguish a user from other users, and may be used, for instance, to authenticate a user. Such data can include a name of the user, date of birth, gender, physical mailing address, email address, phone number, social security number, and so on. The personal data may include one or more of the following: a body type, a skin color, a weight, a height, an agenda, preferences, declarative information, historical purchase data, and historical behavior data. Operational data may include data that relate to the operation of a device or other machine or entity on which a client application is executed. Such data can include IP or Media Access Control (MAC) addresses, device or machine types, clickstreams, web pages or websites visited, search keywords used, and so on. Personal data may include data relating to a user that may be used to help identify the user but that are not necessarily unique to the user. Such data may include family information, such as marital status and number of children; lifestyle information, such as the number and kinds of cars owned, the type and size of home, and the number and types of pets; education; profession; financial data, such as income and net worth; other demographic data, such as ethnicity and religion; customer support data; and so on.

Preference data may include data that reflects opinions and tastes of the user, such as preferences for types of food or clothing, political affiliation, ratings of books, recordings, or other products, and so on. Situational data may include data related to a situation or environment of the user, such as a time, date, entry point, referring campaign, location, weather, time of year or season, and so on. The environmental data may include one or more of the following: weather, pollution, ultraviolet radiation, and location. In further example embodiments, other types of data may be received or generated.

Data associated with multiple users received from multiple data sources 205 can be automatically aggregated to create multiple user profiles as well as to identify relationships between or among users. Each user profile may store all data collected, aggregated, or generated that are association with a particular user. Moreover, historical data that include patterns of past behavior of the user can also be collected. Examples of data sources may include social media, Email Service Provider (ESP) applications (e.g., email), web analytics applications, customer support applications, Customer Relationship Management (CRM) applications, Content Management System (CMS) applications, web advertising applications, point-of-sale systems, mobile tracking technology, other kinds of transmitters or sensors on mobile devices, kiosks, data entered by persons at offline stores, data obtained from web services or publicly accessible or proprietary APIs, and so forth. Examples of relationships between or among multiple users include two or more users being friends on one or more social networks, and one user being married to or a relative of another. Examples of historical data include data associated with a product a user has purchased, a financial history of the user, websites visited in the past, and so on. Data associated with a particular user may be based on websites or web pages that the user visits, the offline stores the user goes to, and a wide variety of online or offline events, such as sending an email, sending a search engine request, making a social media post, registering by physical mail, calling customer support, and so on.

The user profiles can be continuously or periodically updated based on data collected from the at least one of data sources 205. In an example embodiment, the user data may be collected by employing web analytics applications in connection with a website(s) of the company, for instance, by integrating JavaScript snippets, although many other methods for data collection or interception can be used. By default, the systems may integrate JavaScript into a website to automatically create user profiles and personalize the content.

The communication channel orchestration interface 220 may enable a company owner or individual to create or use default business workflows or scenarios for interacting with the users based on available user data. Specifically, the communication channel orchestration interface 220 can allow company staff 250 (e.g., marketers or owners) or individuals to create and maintain a business logic for the user interactions of the user via the plurality of existing communication channels. The business logic can be created in the form of predetermined workflows, scenarios, or business rules. The business logic may include a plurality of trigger conditions and a plurality of actions corresponding to the plurality of trigger conditions.

The at least one marketing action on the at least one subgroup of the prospective clients may be performed by the optimization and personalization engine 230, for example, by mapping content 235 to the user according to the business logic. The optimization and personalization engine 230 may map the content to the user using a recommendation algorithm. Specifically, the optimization and personalization engine 230 may templatize the content to create personalized communication messages for the plurality of existing communication channels.

In an example embodiment, a template for the content may have a plurality of variables, such as a gender, interests, age, products viewed, and so forth, which may ensure that the communication message is personalized. An individual template may be created for each communication channel, such as a recommendation section of a website, an email, an SMS, a pop-up message in a mobile application, and so forth.

The content 235 may be delivered to the user (i.e., to the prospective client) via one or more of existing communication channels 225. According to various embodiments, the communication channels 225 may include electronic mailing systems (ESPs), physical mail delivery systems, graphical user interfaces employed on a website of a company, messaging networks (e.g., cellular networks), and so forth. In an example embodiment, the content 235 may be delivered in a form of emails, physical mail, in-page messages, text messages, push notifications for a tablet or other mobile device, web advertising (e.g., banners) or other advertising, telephone voicemail, or any standard visual, auditory, tactile, or haptic message or signal associated with a computing device. For example, the end user may receive a message with the content 235 via an interface associated with the website of the company, via CRM, CMS, an ESP, a physical mail system, an SMS or other text messaging system, a telephony system, a voice-over-IP (VOIP) system, a graphical user interface, any API accessible to communicate with the end user, or any computing output device known to one of ordinary skill in the art, such as a monitor, speaker, network card, or touch or haptic interface. The content 235 may include an email, physical mail, customer support tickets, in-page messages, web advertising (e.g., banner advertisements) or other advertising, text messages, push notifications for a tablet or other mobile device, telephone voicemail, or any visual, auditory, tactile, or haptic message or signal associated with a standard computing device as is known to one of ordinary skill in the arts.

In some example embodiments, the communication channels 225 may employ some components of a customer support center to allow the optimization and personalization engine 230 to generate the content 235 in a form of a customer support ticket for further resolution of the problem by appropriate personnel. This combination of combination channels 225 and content 235 is defining a marketing action 240.

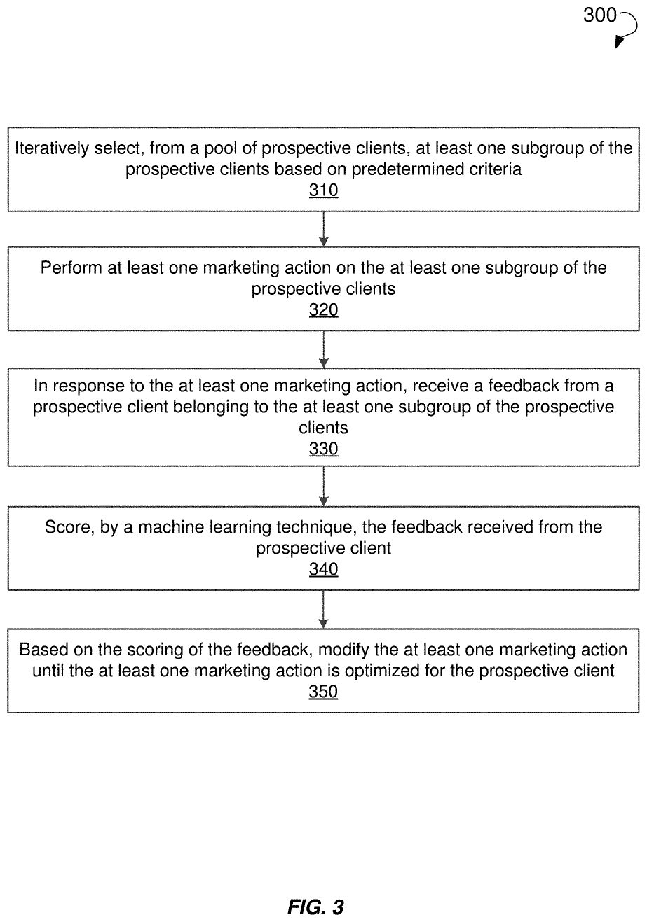

FIG. 3 is a flow diagram that shows a method 300 for optimization and personalization of marketing actions using cloud, hybrid, and quantum-based computing techniques, according to an example embodiment. The method 300 can be performed by processing logic that may be implemented in hardware (e.g., dedicated logic, programmable logic, or microcode), software (such as software run on a general-purpose computer system or a dedicated machine), or a combination of both. In one example embodiment, the processing logic is collocated with the data aggregation module 215 and the optimization and personalization engine 230 shown in FIG. 2 (for instance, they may all execute on the same server).

The method 300 may commence with iteratively selecting at least one subgroup of the prospective clients based on predetermined criteria from a pool of prospective clients in block 310. The method 300 may also include performing at least one marketing action on the at least one subgroup of the prospective clients in block 320. The method 300 may continue with receiving a feedback from a prospective client belonging to the at least one subgroup of the prospective clients in response to the at least one marketing action in block 330. In an example embodiment, the at least one marketing action may be communicated to a user device associated with the prospective client. The user device may include a wearable device associated with the prospective client. The user device may be configured to perform operations associated with one or more of the following techniques: AI, AR/VR, rendering of 3D objects and/or holograms via any communication network including any telecommunication standard such as 5G, IoT, and so forth. For example, the AR/VR may provide one or more of the following features overlaid over physical objects: map directions, client assistance, visualization of marketing messages, promotions, real-time product recommendations, real-time content recommendations, and so forth. IoT devices include all devices that are connected to the Internet. Example IoT devices include sensors, smartphones, watches, glasses, and so forth. By combining the IoT devices with the system, it is possible to gather information, analyze the information, and set up an action plan based on the analysis.

The method 300 may further include scoring, in block 340, by using a machine learning technique, the feedback received from the prospective client. The method 300 may further include modifying the at least one marketing action in block 350. The modifying of the at least one marketing action may be performed based on the scoring of the feedback until the at least one marketing action is optimized for the prospective client.

The at least one marketing action may be part of a multi-sequential marketing scenario personalized for the prospective client. The at least one marketing action may be optimized based on an evaluation of a state of mind of the prospective client. In some example embodiments, the optimization of the at least one marketing action may be performed separately per each communication channel. In further example embodiments, the at least one marketing action may be optimized based on personal data and environmental data associated with the prospective client.

The personal data may include one or more of the following: a skin type, skin color, weight, height, agenda, preferences, historical purchase data, and historical behavior data. The environmental data may include one or more of the following: weather, pollution, ultraviolet radiation, hydrometry, and a location. In further example embodiments, the at least one marketing action may be optimized based on psychographic data. The psychographic data may include one or more of the following: social pressure and personality influencing customer behavior, client maturity, preferences of family members associated with the prospective client, interests, hobbies, emotional triggers, lifestyles, activities, opinions, psychological attributes, a health condition, implied needs, expressed needs, nutrition, habits, and so forth. The psychographic data may use a visual recognition to infer personality traits and assess sentiment.

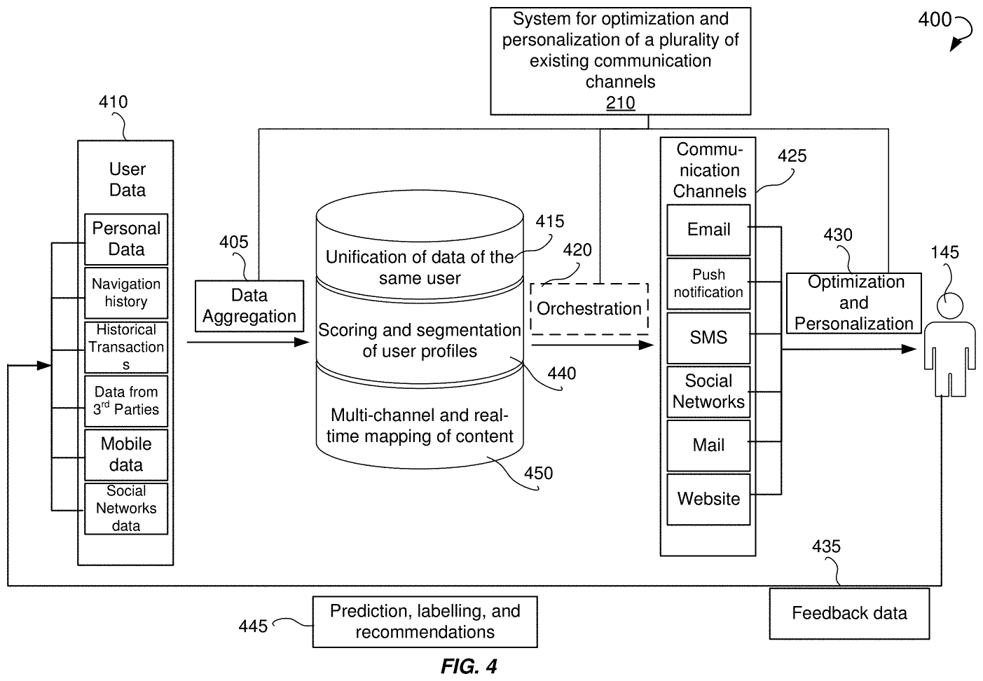

FIG. 4 is a schematic diagram 400 illustrating operation how a system 210 for optimization and personalization of marketing actions works with existing marketing applications and using cloud, hybrid, and quantum-based computing techniques, according to an example embodiment. The system may include a data aggregation module configured to perform data aggregation 405 by aggregating user data 410 received from a plurality of data sources. The user data may be associated with at least one user (i.e., a prospective customer). In an example embodiment, the data aggregation module can be further configured to prioritize the user data using a ranking algorithm.

The user data 410 related to one or more users may include personal data, such as email addresses, names, physical addresses, phone numbers, and the like. The user data 410 may further include navigation history of the user that may include interactions of the user with a website or a mobile application of a company. Other examples of user data 410 include historical transactions of the users, which may include products and services bought by the user on the website or the mobile application of the company. The user data 410 may further include mobile data collected by using functionalities and a software development kit (SDK) of the system, social network data of the user, and data received from third parties.

The data sources may include one or more of the following: user demographics data, location data, gender data, purchase data, content viewed, items purchased, a location, weather, an organization, preferences, an income, historical interactions, third party data, CRM data, Data Management Platform (DMP) data, existing emails, feedback received in response to the user interactions, screen data, personal data, navigation data, historical transactions, a lifestyle, technology used, and so forth.

In an example embodiment, the user data 410 may be collected to feed the user profile from a website using a Java Script and/or collected from a mobile application using an SDK. The Java Script and SDK may also be used to show the content directly on the website and mobile application. The SDK can also be used to display in-app and push notifications. These functionalities create a first party technology part of the system for optimization and personalization of marketing actions using cloud, hybrid, and quantum-based computing techniques.

The data aggregation module may be further configured to create at least one user profile for the at least one user based on the aggregated user data 410. Specifically, the data aggregation module may perform unification 415 of data of the same user. The data of the same user may be stored in the user profile. The user profile may include an anonymous user profile associated with an anonymous user. The user profile may further include an identified user profile associated with an identified user using user credential to login into a website or an application.

In an example embodiment, the data aggregation module may perform scoring and segmentation 440 of user profiles. Specifically, the user profiles may be scored and/or segmented into segments/clusters based on predetermined criteria. Upon clustering of the users based on identical or similar attributes in the user data, the same communication message may be sent to the users in the cluster but the content may be adapted individually for each user in the cluster according to key attributes tracked in the user profile. In an example embodiment, a prospective client 145 may include a segment of users selected based on scoring of the user profiles or selected based on predetermined criteria.

The system may further include a communication channel orchestration interface configured to perform orchestration 420 and management of a plurality of existing communication channels. Specifically, the communication channel orchestration interface may create a business logic for user interactions of the at least one user via a plurality of existing communication channels 425. The business logic may include a plurality of trigger conditions and a plurality of actions corresponding to the plurality of trigger conditions. The existing communication channels 425 may include an email, mobile application, push notifications, SMS, social network messaging or posting, website, customer support ticket, printed mail, and so forth.

The system may further include an optimization and personalization engine configured to perform optimization and personalization 430 of content for a prospective client 145. Specifically, the optimization and personalization engine may be configured to map, using a recommendation algorithm, the content to the at least one prospective client 145 according to the business logic. In an example embodiment, the content may include a product presentation email (with products details), event invite, commercial call, letter, banner on a website, push message in a messenger, and so forth. The products details present in the content may be taken from product data stored in a database. In an example embodiment, the recommendation algorithm may include one or more of the following: an algorithm created by developers of the system (a first party technology), an algorithm created by a third party, a product data feed (which contains product information), a machine learning algorithm, and so forth. In some example embodiments, the recommendation algorithm may be further configured to predict user behavior associated with the at least one user by using machine learning techniques.

For example, for an A/B test, a percentage of users to be exposed to the system may be selected, e.g., 50% with the remaining 50% being in a control group not exposed to the system. Thus, the system may personalize the existing communication channels of a customer (e.g., a product or service provider) for 50% of users of the existing communication channels. The result of the test can include a demonstration of an increase in conversions for the communication channel achieved based on the exposure of the users of the communication channel to the system.

The optimization and personalization engine may templatize the content to create personalized communication messages for the prospective client 145. The optimization and personalization engine may also perform multi-channel and real-time mapping 450 of content to the prospective client 145 by delivering the personalized communication messages to the prospective client 145 using one or more of the plurality of existing communication channels 425 in real time. The optimization and personalization engine may be further configured to index content, ecommerce content, and plain content.

The data aggregation module may be configured by default to receive feedback data 435 in response to user interactions (or lack of user interactions) with the personalized communication messages. In an example embodiment, the user interactions may include one or more of clicks, purchases, webpages visited by the user, opening personalized communication messages, not opening personalized communication messages, and so forth. Based on the feedback data 435, the data aggregation module may update the at least one user profile with the feedback data 435.

The data aggregation module may further update the recommendation algorithm and a next suggestion communication action (e.g., communication needs, communication channel, content, personalization of the content for the user, and so forth) based on the at least one updated user profile. The data aggregation module may further use the feedback data 435 for prediction of user interactions, labeling the user (e.g., identifying the user as a frequent customer, a baby boomer, a millennial, a social traffic user, and so forth), and selecting recommendations 445 (e.g., how the content needs to be personalized) for the user.

The feedback data 435 may show the time an email sent to the prospective client 145 was opened, links the prospective client 145 clicked, whether the prospective client 145 opened the website linked in the email, and so forth. The feedback data 435 may be stored to the user profile for personalizing further content (e.g., further email) and for selection of communication channels for further communications with the prospective client 145 (e.g., prospective client 145 never opens emails, another communication channel can be selected for further communications with the user).

The data aggregation module 405 may be further configured to enrich the user data using an AI technique. In some example embodiments, the data aggregation module 405 may be further configured to combine several data sources of the plurality of data sources for predicting user behavior associated with the at least one prospective client 145, clustering prospective clients, or for other purposes.

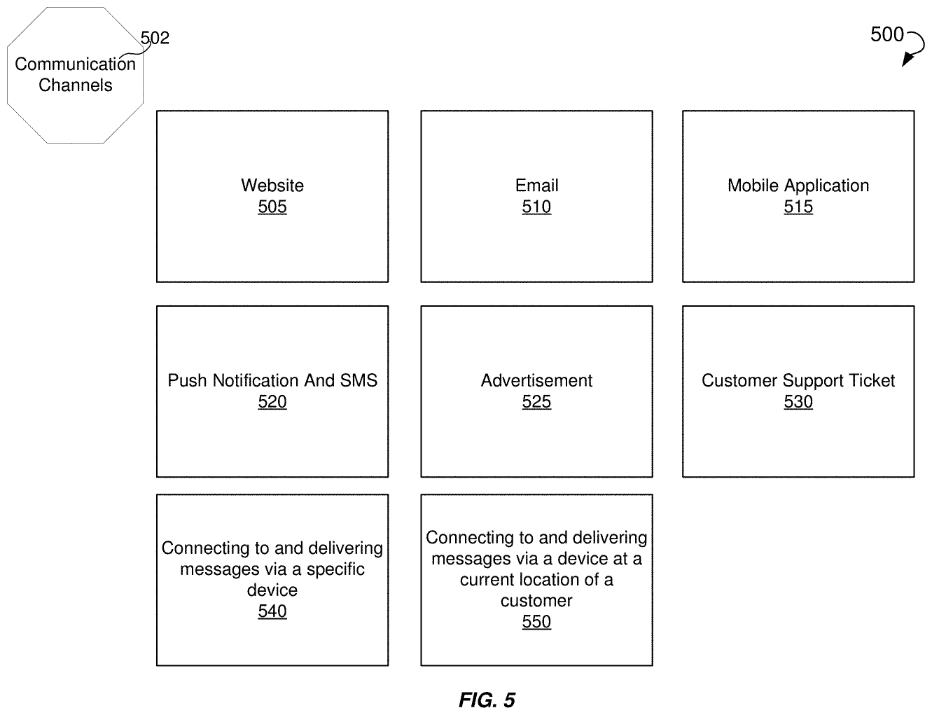

FIG. 5 is a summary diagram 500 showing all the communication channels 502 used by the system 210 for optimization and personalization of marketing actions using cloud, hybrid, and quantum-based computing techniques, according to an example embodiment. The optimization and personalization engine may map personalized content to the user according to the business logic. The content may be provided to the user using one of communication channels 502, such as a website 505, an email 510, a mobile application 515, a push notification and SMS 520, an advertisement 525, a customer support ticket 530, connecting to and delivering messages via a specific device 540 (e.g., augmented reality glasses) to a customer, connecting to and delivering messages via a device 550 located at a current location of a customer (e.g., a display in a shop where the customer is currently located), and so forth.

The systems and methods for optimization and personalization of marketing actions using cloud, hybrid, and quantum-based computing techniques are based on six main principles. These principles include self-optimizing content, a multi-sequential marketing scenario for each user, a state of mind of each user, contextual personalization, psychographic data, and quantum Internet.

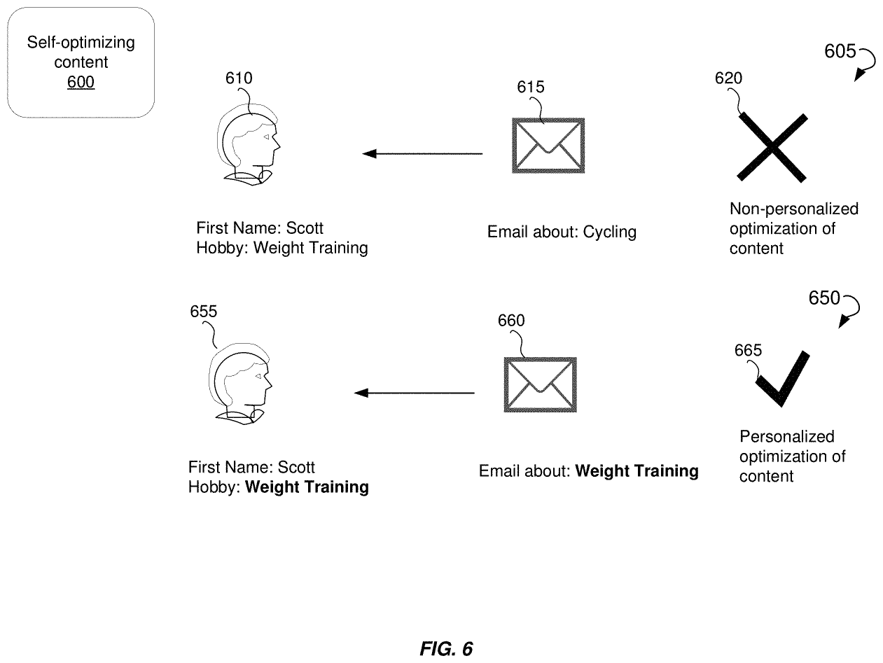

FIG. 6 is a schematic diagram illustrating generation of a self-optimizing content 600 by the system for optimization and personalization of marketing actions using cloud, hybrid, and quantum-based computing techniques, according to an example embodiment. Flow 605 illustrates an approach used by conventional systems for selecting content to be delivered to users. In traditional marketing, there is a belief that exercising constant messaging pressure on buyers would increase their likelihood of buying. However, multiplying irrelevant messages does not optimize the likelihood of convincing a prospective client considering the content is not engaging the prospective client personally. Specifically, in traditional marketing systems, user data associated with user 610 are analyzed. The user data may include a name, a hobby, and so forth. Based on the user data, the system may determine that the user 610 is interested in sports because the user 605 likes weight training. All users interested in any sports may be clustered in the same group and receive the same types of emails. In particular, the system may personalize an email 615 based on the user data and send the email 615 to all users interested in sports, including the user 610. However, as the user 610 is only interested in weight training, not in other sports and, therefore, the content provided to the user in the email 615 is irrelevant to the user 610 because of non-personalized optimization 620 of the content by the conventional system.

FIG. 6 further shows a flow 650 that illustrates an approach used by the system for optimization and personalization of marketing actions using cloud, hybrid, and quantum-based computing techniques. In a quantum approach, the system deploys qualitative energy to provide to the evolution wanted. For example, a user 655 is interested in weight training. Sending an invitation email 660 to the user 655 for a session to test new boxing gloves (i.e., an email relating to weight training) may be more efficient than repeatedly soliciting the user 655 with messages about all sporting equipment available at a shop (as in traditional approaches). Sending the personalized email 660 may result in personalized optimization 665 of the content by the system for optimization and personalization of marketing actions using cloud, hybrid, and quantum-based computing techniques.

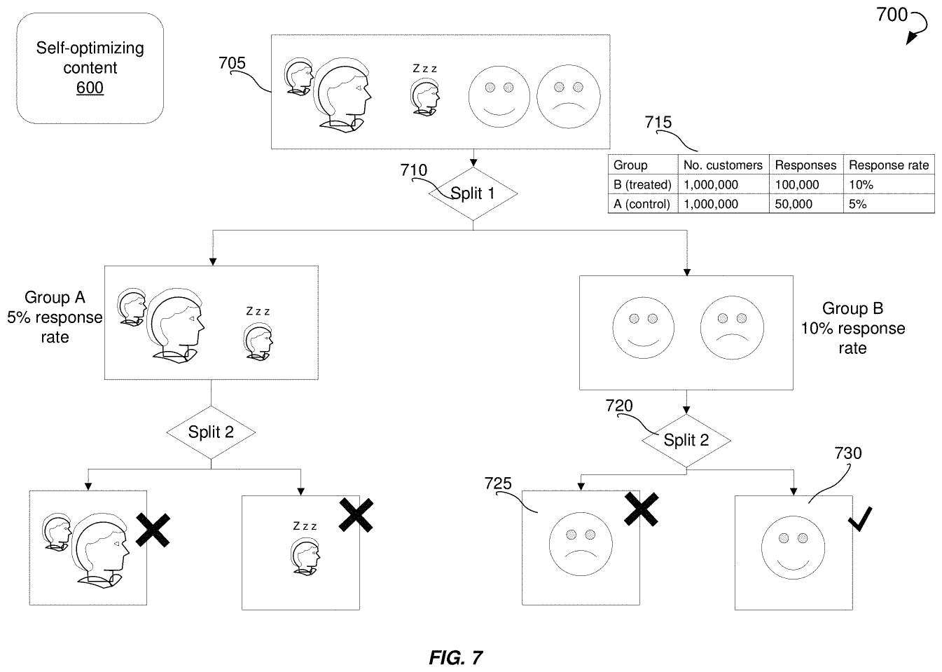

FIG. 7 is a schematic diagram 700 illustrating testing of the population by the system for optimization and personalization of marketing actions using cloud, hybrid, and quantum-based computing techniques, according to an example embodiment. FIG. 7 illustrates performing an advanced A/B test on users iteratively following the uplift modelling also known as incremental modelling, true lift modelling, or net modelling. The goal of this predictive modelling technique is to make sure the system targets the right person with the right message at the right time. To identify target users in a group 705 of users, the system performs A/B testing of the population of the group 705 with uplift modelling. The uplift of a campaign is usually defined as the difference in response rate between a treated group and a randomized control group. The aim is to identify the performance of that individual marketing action. This can be illustrated by the A/B test.

In split 1 710, users of the group 705 are divided into two groups. The control population (i.e., a group of users not exposed to the system) is named group A and the treated population (i.e., a group of users to which the message is sent) is called group B. Based on the performance illustrated in table 715, since the control group (group A) has only a 5% response rate, the message sent to users of group A is either not suitable for the users or inaccurate people were targeted. Sending the message to users of group B resulted in 10% response rate.

In split 2 720, there is a 10% response rate, and the system may randomly test the group B to identify the population that did not seem interested (90%) and the common criteria between these prospective clients. The system identifies common characteristics of the 90% of users that are not responding positively in order to avoid sending the same message to this group of users. The system may send another type of message to group 725 and group 730 and determine the response rate of users of each of group 725 and group 730. The system can then continue A/B testing by iteratively splitting users into groups and optimizing messages to identified groups of users. The result of the test can be a demonstration of an increase in conversions for a specific content (e.g., a content) sent via a specific communication channel (e.g., email), which may be achieved based on the exposure of the users of the communication channel to the system. The response rate of groups of users exposed to receiving specific messages serves as a feedback loop to determine a target group of users and content to which the target group of users responds.

The self-optimized content may be delivered to users via wearable devices, such as computers, phones, music players, devices having 5G, 3D, AR/VR, and AI functionalities, AR glasses, speakers, and so forth. Prospective clients may be able to visualize the received message instantaneously. The self-optimization of the content for presenting in the message may be performed immediately based on current data associated with the prospective clients.

In an example embodiment, AR glasses may be used for fitting a room anywhere, e.g., to try a product with 3D rendering from any environment. The AR glasses may further provide interactive experience between physical and online spaces, which can be merged with advanced computational power and 5G. The AR glasses may ensure real-time data user-specific personalization due to accessing a 360° data input on each user to individualize each message for each specific user.

In an example embodiment, user named Jane is a buyer addicted to luxury handbags, not very interested in shoes, and having enough footwear options. Jane lives in San Francisco and likes to go for a walk during her free time.

In traditional approaches, Jane is detected to have interests in both the fashion and shoes categories. Communications to be provided to Jane are optimized at a segment level via A/B test capabilities. Jane will not buy trendy clothing or shoes; therefore, the data collected would not be used optimally. Indeed, the content provided to Jane may be not unique to browsing activity and personal needs of Jane. In a nutshell, product and service providers may lose time and money in communicating irrelevant information to Jane.

In quantum content optimization of the present disclosure, product and service providers may optimize the user journey for Jane based on the appropriate use of relevant data. The messages may be triggered by real-time data and optimized by the uplift modeling. The product and service providers can build a customized and unique message, e.g., with the following email subject line: “Jane, this weekend, discover your ‘brand name’ handbag selection in Marina”. At the end of the week, Jane may most likely stop at the store nearby.

Furthermore, relevant recommendations may be immediately displayed to prospective clients. Experiences may be engaging and personal. By combining quantum computing, immersive experience, reinforcement learning and AI, product and service providers can reach the maximal efficiency. The individualized messages may be displayed by wearable devices (connected glasses) offering interconnected experiences with the physical world and multiple shopping scenario.

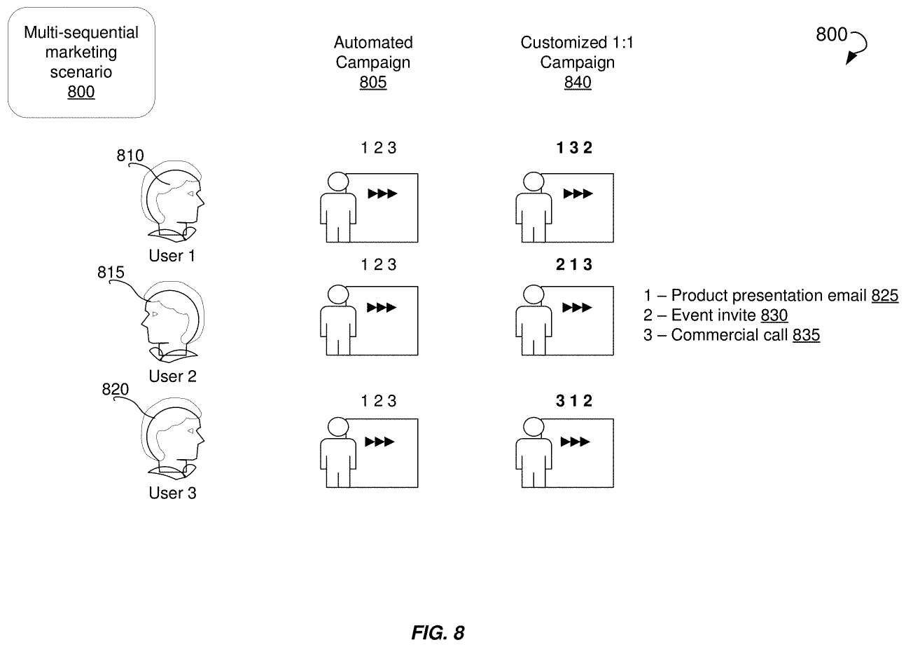

FIG. 8 is a schematic diagram illustrating selecting a multi-sequential marketing scenario 800 by a system for optimization and personalization of marketing actions using cloud, hybrid, and quantum-based computing techniques, according to an example embodiment. Traditional approaches for communicating with users trigger automated messages in a predefined and sequential way. These siloed communications are typically universal and do not maximize the performance for each individual user. Consequently, the goal of the system is to determine the next best marketing action. To find the optimal scenario for the user, a touchpoint with the highest probability of sale should be identified for each individual.

For example, in conventional automated campaign 805, user 1 810, user 2 815, and user 3 820 receive the same sequential marketing scenario: 1) product presentation email 825, 2) event invite 820, and 3) commercial call 835. This communication strategy is not adapted to each user because while user 3 820 prefers an informative phone call, user 2 815 likes to go to events to discover new products. In this case, only message sent to user 1 810 may be converted into a response from the user 1 810 because the user 1 810 likes to have news delivered by mail.

In customized 1:1 campaign 840, a specific multi-sequential marketing scenario 800 is developed by the system for user 1 810, user 2 815, and user 3 820. According to multi-sequential marketing scenario 800 for user 1 810, the user 1 810 may first receive a product presentation email 825, then receive a commercial call 835, and then receive an event invite 830. The multi-sequential marketing scenario 800 for user 2 850 may include sequential sending of the event invite 830 and product presentation email 825, and further making a commercial call 835. According to multi-sequential marketing scenario 800 for user 3 820, the user 3 820 may first receive a commercial call 835, then receive a product presentation email 825, and then receive an event invite 830.

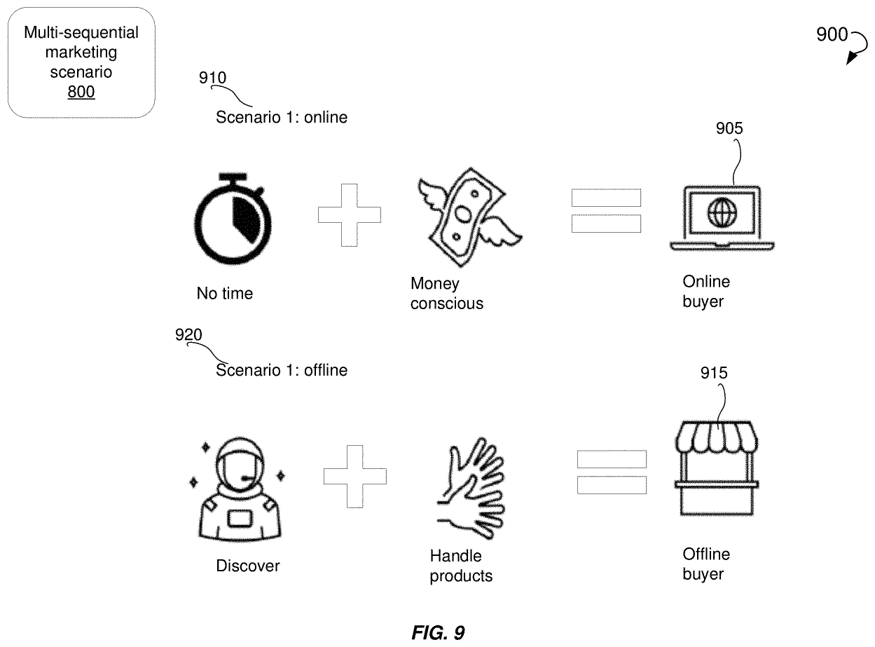

FIG. 9 is an example diagram 900 demonstrating creating a multi-sequential marketing scenario 800 online and offline by a system for optimization and personalization of marketing actions using cloud, hybrid, and quantum-based computing techniques, according to an example embodiment. The system can create the multi-sequential marketing scenario 800 to converge online and offline worlds for a prospective customer. The system can create adequate multi-sequential marketing scenarios according to the mood of prospective customers. For example, if a prospective customer has no time and is money conscious, the system determines that prospective customer is potentially an online buyer 910 and selects scenario 905. The scenario 905 may include interacting with the prospective customer online, e.g., by sending emails. If a prospective customer likes to discover new things and handle products, the system can determine that prospective customer is an in-store buyer 915 and selects scenario 920.

There is a multitude of possible marketing scenarios. For example, inside the physical store, a sales assistant can invite their prospective clients to become actors and improve shopping experience with augmented reality applications to visualize products.

For online buyers, virtual shops may be disrupted by a new way of consuming. Currently many brands are offering their products and services in their 3D stores. Virtualized products are presented immersively for purchase online. The quantum marketing may maximize both the content messaging and the marketing sequence and provide each client with a distinctive 3D store according to their habits, preferences, and interests. The system may use the quantum approaches to predict the optimal merchandizing, pricing, promotion, and experiences for specific customers.

For in-store buyers, the system may provide an optimized experience for digital assistance in retail. Some consumers need to discover, manipulate, and try, for example, expensive items. In that case, in-store retail is a must. Retailers may aggregate computer vision, sensor, and deep learning to create shops, in which specific user experience is tailored to onsite buyers.

In conventional approaches, current user experience is identical for everyone in its reliance on brick and mortar stores. Customers receive automatized messages in a predefined and sequential way. Virtual stores are limited in their functionalities and not differentiated on a user-level. They lack the capability to match the habits, preferences, and interests of prospective clients. In a nutshell, the full process is automated, not optimized, and misses assistance and personalization.

The system of the present disclosure provides personalized customer experience by making a personalized virtual store accessible anywhere at any time. The calculation capabilities provided by the quantum technologies may optimize the scenario at an individual level where the touchpoint with the highest probability of sale may be identified for each customer. Virtual stores may focus on immediacy, immersion, and interaction predicting the optimal merchandizing, pricing, promotion, and experiences. The frontier between the physical and digital worlds may blur offering a new “quantum journey” with each environment completing the other one.

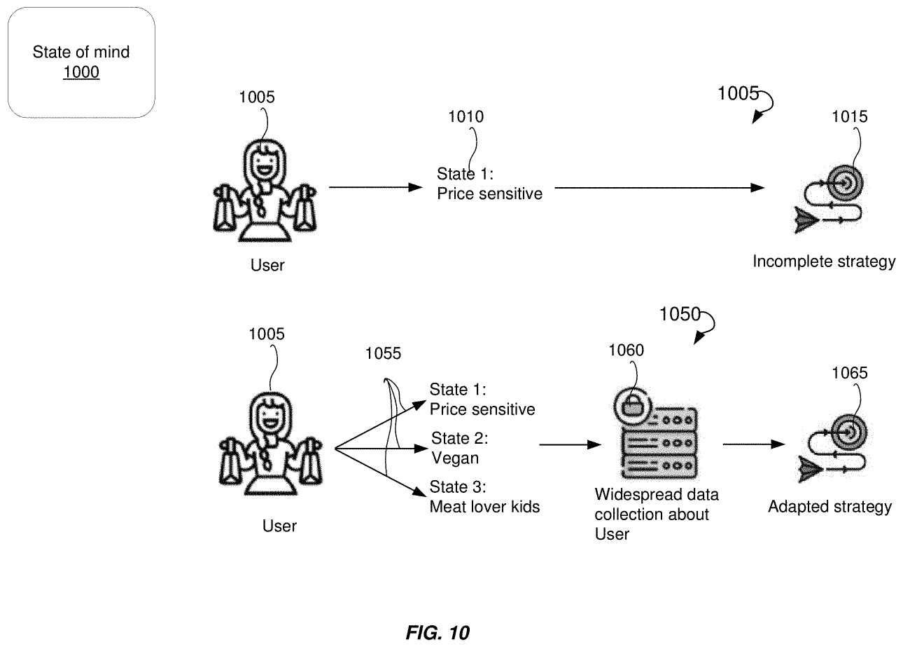

FIG. 10 is a schematic diagram illustrating determining a state of mind 1000 of a prospective customer by a system for optimization and personalization of marketing actions using cloud, hybrid, and quantum-based computing techniques, according to an example embodiment. With consumers having their mobile device at a fingertip and mass marketing like TV campaigns losing their efficiency, it is crucial to understand the mindset of clients (e.g., millennials). Product and service providers may use all data to have a 3600 view of weak signals (qualitative study on needs, digital measuring of behavior) as traditional marketing through segmentation is not sufficient anymore.

As shown in FIG. 10, in a traditional approach 1005, only one state 1010 (e.g., a price sensitive user) of a user 1005 is determined. This may result in creating an incomplete strategy 1015 of communication with the user 1005.

According to an approach 1050 used by the system of the present disclosure, three states 1055 of the user 1005 may be determined. The states 1055 may include being price sensitive, being a vegan, and being a mother of meat loving kids. User 1005 might be a vegan single mother living on one paycheck with meat loving kids. Therefore, the user 1005 is in three mindsets (also referred to as superposition): state 1 is price sensitive; state 2 is vegan; and state 3 is food for kids. Based on the states 1055, widespread data 1060 may be collected in association with the user 1005. An adapted strategy 1065 for communication with the user 1005 may be created based on the states 1055 and widespread data 1060.

Classic computers are deterministic and operate serially by testing possibility successively. Quantum computers may operate based on probabilistic and simultaneousness principle. Therefore, the system may increasingly optimize and personalize the way of communication with clients. With quantum computers, data is aggregated instantly and triggers the right message via the right marketing channels taking advantage of user profile unification, scoring, and segmentation and real-time mapping of content. The “quantum journey” may include prediction, optimization, and personalization with advanced computational power and infinite scenarios.

Therefore, the quantum computing provides an ability to build content and strategy for each state of mind of a customer, provides real-time limitless data capacity and overcomes simplified segmentation. These advantages may be useful in predicting, optimizing, and personalizing for customers and drive more conversions and re-engage existing clients.

The system of the present disclosure may be configured to develop multitude of mindsets and communication strategies for a customer. The system may create scenarios according to a different mood of customers. All the weak signals from the customer (e.g., not attending a shop for predetermined time) may be consolidated into a comprehensive customer profile. The system may probabilistically and simultaneously multiply the capabilities to render individualized content for one user (e.g., a shopping list). The system may anticipate every state of mind of customers for maximum personalization of communication channels.

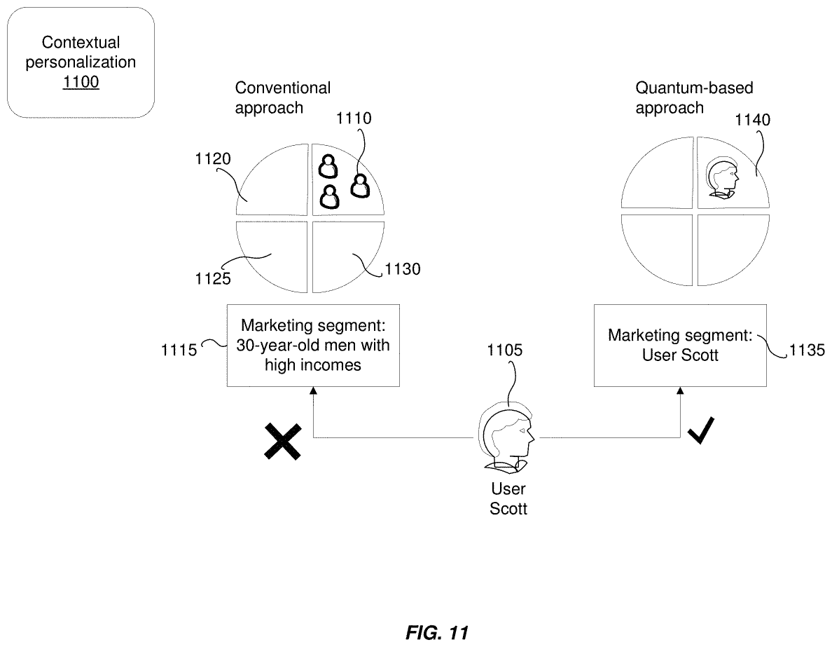

FIG. 11 is a schematic diagram illustrating performing contextual personalization 1100 by a system for optimization and personalization of marketing actions using cloud, hybrid, and quantum-based computing techniques, according to an example embodiment. In conventional approaches, companies are relying on 5 to 19 customer segments to build their customer experience. For example, a user 1105 is attributed to a group 1110 of customers (e.g., a 30-year-old men with high incomes) based on user data 1115 collected in association with the user 1105.

Instead of establishing homogenous groups (e.g., clusters shown as group 1110 and groups 1120, 1125, and 1130), the system of the present disclosure creates a strategy 1135 for a segment of one user. According to the strategy 1135, the user 1105 is clustered into a group 1140 that includes only user 1105. Therefore, user 1105 is viewed as an individual and is treated differently from his peers.

Thus, the system provides 1:1 true personalization of content delivered to each user. For example, even when a customer visits a website without logging in into a user profile on the website, the system may determine the location of the user and weather conditions at the location and personalize the content displayed to the user based on the location and the weather conditions.

Moreover, in conventional approaches, product and service providers only work on a limited quantity of segments. The user profiled as a “30-year-old man with high income” illustrates the execution constraints in terms of data and content. However, all the data sources informing about the context associated with the user are not aggregated. In addition, the organizations are making assumptions and executing a fragmented strategy by siloed marketing channels. Indeed, the personal level in the experience is missing today. For example, when using AI, habits, location, weather, agenda, and all environmental data of the user are not taken into account to contextualize a personal response for the user. The conventional approach is a one-dimensional approach without a consistent way to reach out to users on a 1-1 basis.

In contrast, the system of the present disclosure segments the user into a group of one user. With solutions powered by 5G, AI, and other technologies, the system collects in-depth data about the user, such as who the user is, what the user likes and where the user is in real-time. Consequently, powerful contextualization can be driven to any accessible device at home, work or on the go. The recommendation may be adapted to research, preferences, historical information, and other data associated with the user. The system may improve the knowledge of each unique person by extracting information from each system collecting data about the user. The answers may be multi-dimensional. The system may provide customers with a day-to-day assistant capable of reorganizing their agenda and meetings in a blink of an eye according to real-time priorities, weather, and so forth.

Consumers may adopt and use convenient services and products where immediacy and simplicity may be part of a highly contextual experience. Strategies may focus not only on what is delivered but also on how the content is delivered to each customer. Personal experiences deliver relevant content and function based on explicit and implicit feedback about customer needs and preferences. Contextualization may combine and extend existing segmentation and personalization techniques with real-time details. Cloud, hybrid, and quantum-based technologies may improve the knowledge of each unique person to provide a predictive (but not overwhelming) customer experience.

In an example embodiment, the system may use AI technologies to take into consideration a segment of a user to offer the user the best unique experience by considering a significant number of parameters, such as skin type, skin color, weight, height, agenda, expenses, preferences, past purchases, weather, hydrometry, pollution, ultraviolet radiation, and so forth. These extended AI functionalities of wearable devices may link all these data together and understand the context and environment of the user. Thus, quantum computing may be used to predict buying patterns of users. For example, through a connected mirror, a user may visualize the right product displayed in front of the user. The mirror may become a day-to-day digital assistant of the user. This product may likely be purchased, because this product is targeted for the correctly identified unique segment (the user).

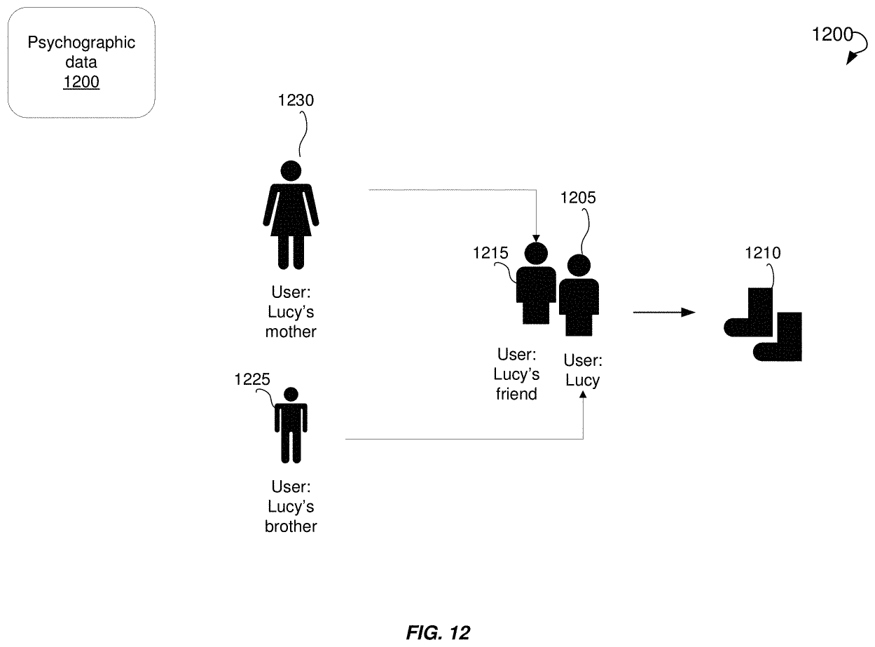

FIG. 12 is a schematic diagram illustrating determining psychographic data 1200 by a system for optimization and personalization of marketing actions using cloud, hybrid, and quantum-based computing techniques, according to an example embodiment. In addition to the state of mind and contextual personalization, other factors exist, such as the social pressure and personality that influence the customer behavior. Therefore, a client may be considered as a target unlinked with any other person. Customers do not make their decision alone. These influence factors are measurable considering the maturity of the customer including all the decision-makers, users, members of a family, or buyers participating from near or far. These psychographic data may also be taken into account.

As shown in FIG. 12, a user 1205 (Lucy) may hesitate as to whether to buy a new pair of shoes 1210, whether to consider the fact that Lucy's friend, user 1215, bought the same pair of shoes, and whether to consider the fact that her brother, user 1220, read negative reviews about the shoes 1210. A user 1230, Lucy's mother, wants the user 1205 to have new shoes 1210. These opinions may matter to the user 1205 and may impact a decision of buying the shoes 1210 by the user 1205.

The system may collect all data related to user 1205, user 1215, user 1225, and user 1230 as psychographic data 1200 associated with the user 1205 that may explain the behavior of the user 1205. While demographic data are based on factors such as age, race, and sex, psychographic data take into account the interests, hobbies, emotional triggers, lifestyle, and so forth.

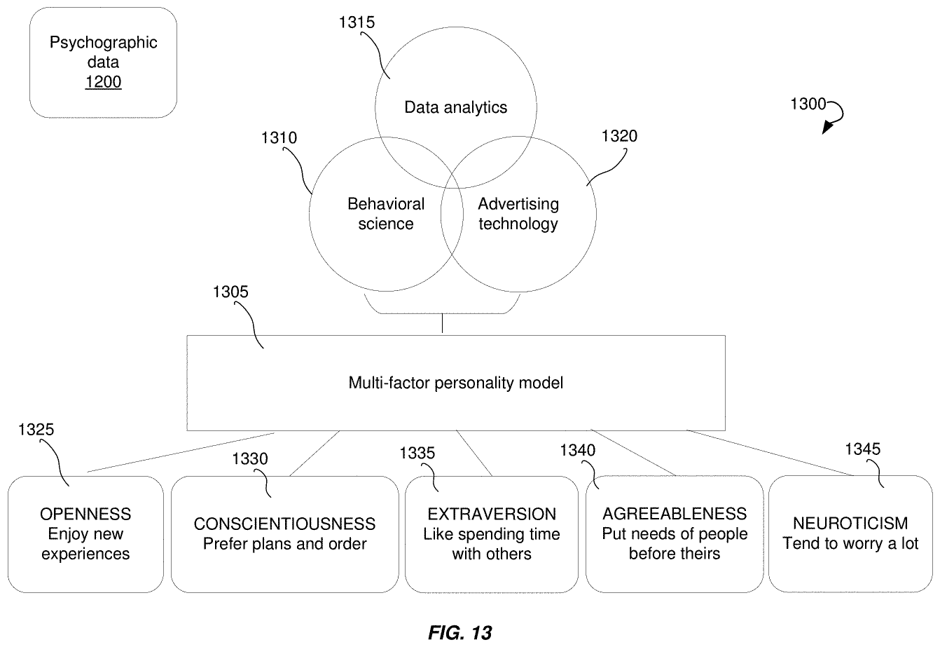

FIG. 13 is a schematic diagram 1300 illustrating a multi-factor personality model 1305 developed based on psychographic data 1200 associated with a user. Psychographics is the study of consumers based on their activities, interests, and opinions. Behavioral science 1310, data analytics 1315, and advertising technology 1320 may be used for collecting psychographic data 1200. Behavioral science 1310 is influenced by context, emotions, and social norms. Behavioral science 1310 activates cognitive biases to facilitate decision-making. This influences several variables. Psychographics combine analysis of personalities of users with identity data, demographics and more, to predict and influence mass behavior. The multi-factor personality model 1305 defines different psychological traits of a user. The psychological traits may include the OCEAN personality model including 5 components: Openness 1325 (enjoy new experiences), Conscientiousness 1330 (prefer plans and order), Extraversion 1335 (like spending time with others), Agreeableness 1340 (put needs of people before theirs), and Neuroticism 1345 (tend to worry a lot).

The multi-factor personality model 1305 may reshape the way how data are collected, analyzed, and applies in digital marketing. The multi-factor personality model 1305 makes it possible to gain deeper insights into psychological and emotional motivations of target users and therefore provide more relevant messaging to these audiences.

Psychographic profiles of audience segments can also explain the behavior and be directly coming from exploration and visual interpretation from social networks or visited websites, sentiments and keywords analysis from a customer review, a social post or a forum, personality prediction from any text such as a cover letter, blog, social network, email, quote, and so forth.

The system for optimization and personalization of marketing actions using cloud, hybrid, and quantum-based computing techniques may predict the behavior of consumers by knowing exactly their personality, health condition, habitation, implied or expressed needs, nutrition, lifestyle, habits, and so forth.

The qualitative data coming from every data or marketing systems as well as devices used by the clients may be also collected. By using AI technologies, the system may predict in real-time the type of advertising and content to reach out personally to every prospective client. New data points may be calculated immediately depending on emails, notifications sent, customers posts on social media for example, what customers ask on the Internet, and so forth. Psychographics data may be key to deliver performance.

In an example embodiment, the system may use AI and machine learning techniques to analyze potential consumer communities to extrapolate interests, hobbies, emotional triggers, lifestyle, and so forth. With visual recognition, inferring personality traits, assessing sentiment and keywords, brands expand their understanding of their persona and to reach a bigger and bolder audience.

Machine learning is an AI method in which data are analyzed using computer algorithms that improve automatically through experience and by the use of data. Machine learning models used by the system of the present disclosure may include neural networks, such as a convolutional neural network, an artificial neural network, Bayesian neural network, supervised machine learning neural network, semi-supervised machine learning neural network, unsupervised machine learning neural network, reinforcement learning neural network, and so forth.

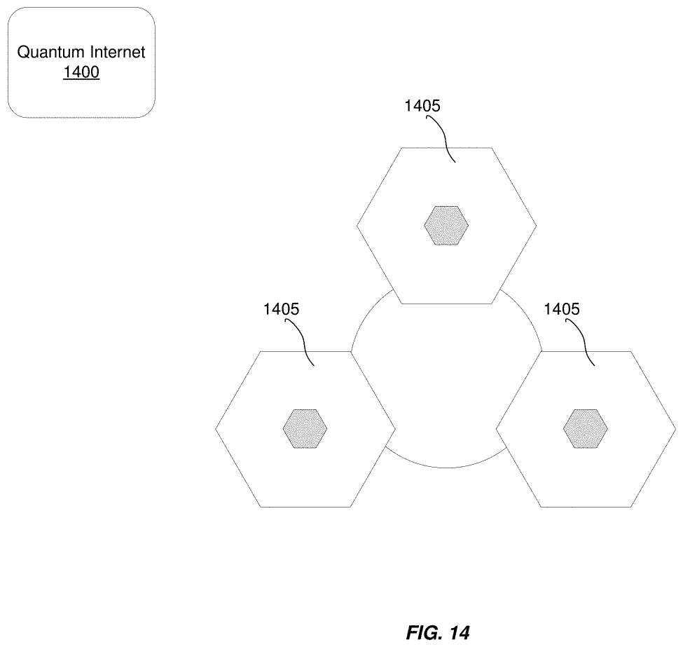

FIG. 14 illustrates a schematic diagram of a quantum Internet 1400 that may be used by the system for optimization and personalization of marketing actions using cloud, hybrid, and quantum-based computing techniques, according to an example embodiment. The quantum Internet 1400 may include a plurality of interconnected quantum computers 1405.

The quantum Internet 1400 may complement the regular Internet by connecting quantum computers 1405 within a dedicated environment supporting quantum mechanics. The quantum Internet 1400 may offer unprecedented capabilities that are impossible to carry out with currently existing web applications. Consequently, the customer may be always connected and become omniscient. This may result in the rise of the “knowledgeable customer” era with different buyer types, such as a savvy client (who compares prices on his computer and smartphone), a curious customer (who learns all about products and services (characteristics, comparisons, reviews) prior to validation of their decision), a relationship buyer (who solicits and contributes to the community (Q&A, advice)), and a conflicted purchaser (who is no longer satisfied with the brief responses of salespeople).

Additionally, sellers may interact with hologram vendors to receive advice, build a history purchase, or a wish list. For example, Mary is a guitarist and wants to buy a new guitar. Mary has her favorite guitar model, knows the brand and the specifications, but Mary is not sure about the grip. Mary wants to try the grip but does not have a store near her house. With the connected TV, Mary can browse the Internet, go to the website, and select the guitar Mary would like to try. Using a 3D projection, Mary can visualize the size “in real life” and try it, and seek advice from a hologram vendor, in the comforts of her own home.

With quantum computing, customer may be tracked in all ways. Each interaction, research, purchase, may be tracked. Sensors may be located everywhere, in different areas such as: material qualification, biology and medicine (cell microscope), geoscience with discovery of ground water/oil, underground, cavities, and so forth, environment by helping to predict natural disasters (earthquakes). The data being collected and linked together may become a unique digital fingerprint of a person. Based on the unique digital fingerprint, product and service provides may operate with more precision and insight and focus attention on who exactly the customer is and on what the customer really needs.

In an example embodiment, biometrics of users may be recognized and used for content personalization. With eye-tracking, it may be possible to track how eyes behave and therefore make some diagnosis, for example, bipolar or schizophrenia. Eye-tracking makes it possible to understand where a virtual reality user is looking, and optimize the resolution of what they see. Consequently, eye-tracking can save resources by putting high definition only where the user in virtual reality is looking. By analyzing exactly what and where the user is looking, it may be possible to analyze user behavior, see if the user likes the product or not, and create an increased immersive scenario.

Currently, customers are tracked with cookies, by integrating JavaScript code into websites. The cookies track a lot of information such as: following the visitor journey, saving login details, and browsing preferences. The use of cookies makes it possible to recognize a visitor who has already come to the website to offer them an experience adapted to their needs. The customer is autonomous in the act of purchase but still needs advice from vendors.

With quantum computing, the future may include biometric tracking: eye tracking with retina, touch sensors, chips that are connected to our bodies. Biometric authentication already allows people to be free from passwords. Cookies provide a more efficient way to track data from customers, while with eye-tracking it may be possible to offer users the best shopping experience. Quantum computing may allow the customer to be omniscient, so the customer already may know what they are looking for, how it is working, etc. Therefore, a value-added unique customer experience may be provided to customers.

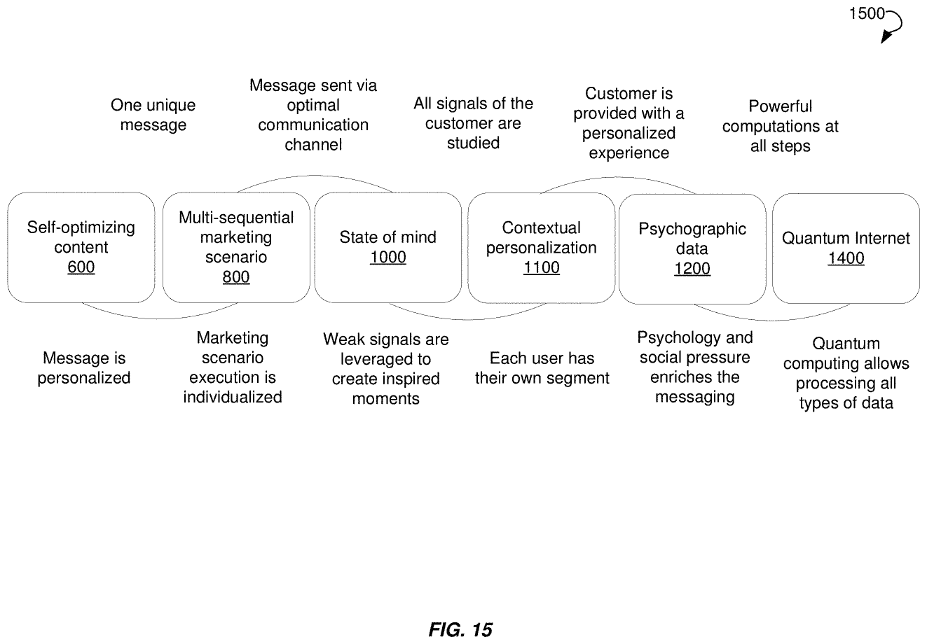

FIG. 15 is a schematic diagram 1500 combining six principles used by the system for optimization and personalization of marketing actions using cloud, hybrid, and quantum-based computing techniques. The use of six principles may result in generation of one unique message for a particular user and sending the message over a communication channel selected as the most applicable communication channel for triggering an interaction of the customer with the message. To select content for the message and the communication channel, all signals (i.e., data) associated with the customer may be studied to provide the customer with a personalized experience. At all steps, powerful computing computations, e.g., by using a quantum computer, may be used.

Therefore, the principle of self-optimizing content 600 may result in personalization of the content in the message for the customer. The principle of multi-sequential marketing scenario 800 may result in individualizing the execution of the marketing scenario for the customer. The principle of the state of mind 1000 provides leveraging of weak signals associated with the customers (e.g., opinions of other people) to create inspired moments in the customer experience. Due to the contextual personalization 1100, each user may be clustered into an individual segment. The collection of psychographic data 1200 may enrich the messaging. Quantum computing used on the quantum Internet 1400 allows processing all types of data.

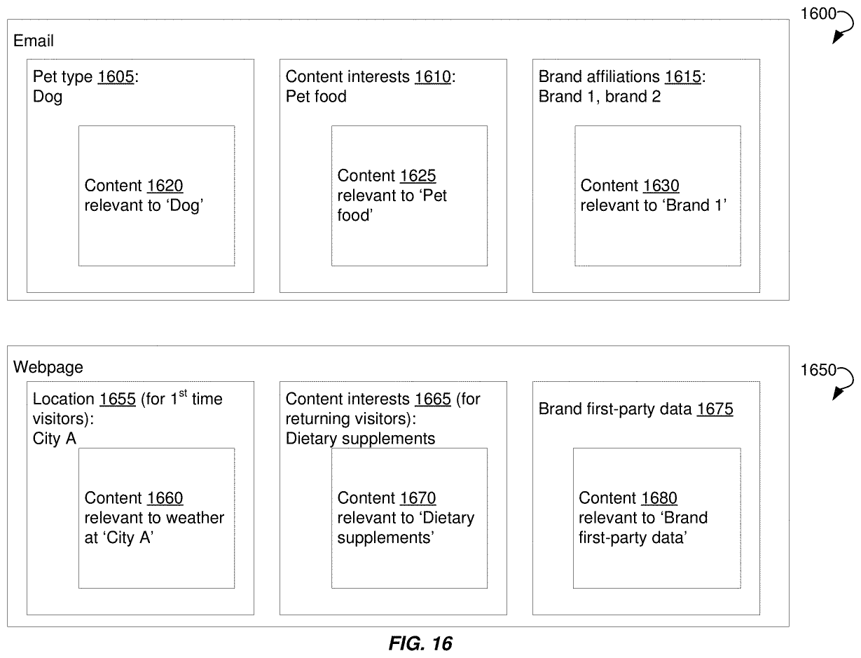

FIG. 16 shows schematic diagrams illustrating a content-driven example use case of a system for optimization and personalization of marketing actions using cloud, hybrid, and quantum-based computing techniques. Based on collected data associated with a user and applying technologies discussed in the present disclosure, the system may personalize an email 1600 sent to the user that subscribed to a website and personalize a web page 1650 of the website of a product provider.

The email 1600 delivered to the user may be personalized specifically for the user. In particular, the system may determine that the user has a dog, buys pet food online, and prefers a specific brand. The system may personalize the email 1600 based on a pet type 1605, content interests 1610, and brand affiliation 1615. Specifically, the personalized email 1600 may include content 1620 relevant to dogs, content 1625 relevant to pet food, and content 1630 relevant to the specific brand.

The webpage 1650 may be personalized based on a location 1655 of the user if a user is a first time visitor of the webpage 1650. For example, the personalized webpage 1650 may include a content 1660 relevant to the weather at the location 1655 of the user. If the user is a returning visitor, the webpage 1650 may be personalized based on content interests 1665 of the user determined based on previous visits of the user. For example, the personalized webpage 1650 may include a content 1670 relevant to dietary supplements in which the user is interested. Moreover, brand first-party data 1675 may be leveraged to personalize the webpage 1650. The personalized webpage 1650 may deliver content 1680 with customized brand communications in real time.

The personalized email campaign and webpage personalization may result in increase in sales, increase in affinity for the brand, increase user engagement, and increase the database of users multiple folds.

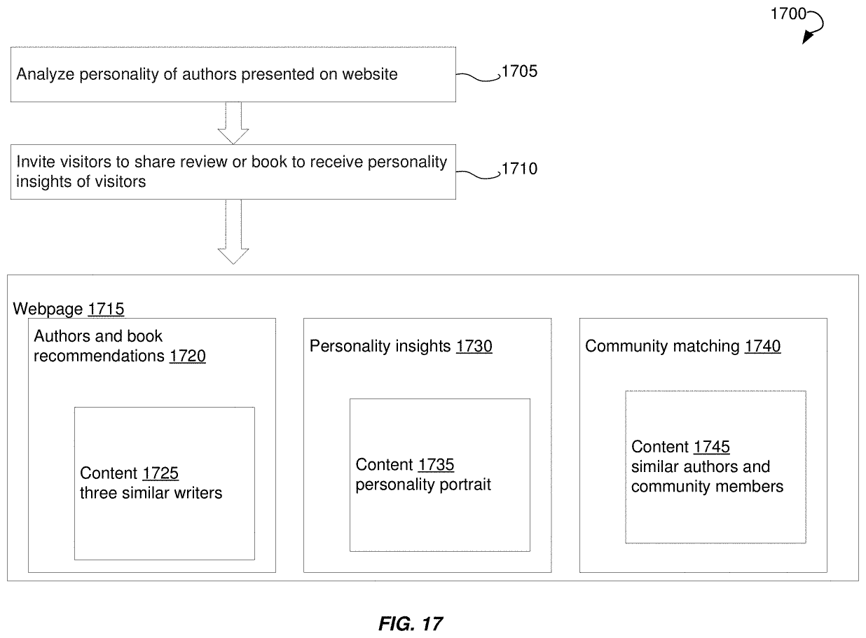

FIG. 17 shows a schematic diagram illustrating a psychographic-driven example use case 1700 of a system for optimization and personalization of marketing actions using cloud, hybrid, and quantum-based computing techniques. At step 1705, the system may leverage the cognitive capabilities to analyze the personality of a plurality of authors books of which are presented on a website (e.g., an online bookstore) based on writings of the authors and determine similar authors and books. At step 1710, the system may invite visitors to share a review or book to get personality insights of the visitors. Based data collected at steps 1705 and 1710, the system may generate a personalized webpage 1715 for a visitor.

The webpage 1715 may be personalized based on authors and book recommendations 1720 and may include content 1715 suggesting three similar writers from “favorite authors” selected by the visitor. The webpage 1715 may be further personalized based on personality insights 1730 and may include content 1735 offering users to receive personality portrait from the review or social media accounts of the visitor. The webpage 1715 may be further personalized based on community matching 1740 and may include content 1745 showing similar authors and community members based on a personality portrait of the visitor.

FIG. 18 shows a diagrammatic representation 1800 of a quantum processing unit 1805 (also referred to as a quantum computer) that may be configured to perform any one or more of the methodologies discussed herein. In some embodiments, the quantum processing unit 1805 operates as a standalone unit, while in other embodiments it can be connected (e.g., networked) to other quantum processing units. In a networked deployment, the quantum processing unit 1805 can operate in the capacity of a server, a client machine in a server-client network environment, or as a peer machine in a peer-to-peer (or distributed) network environment. The quantum processing unit 1805 may include one or more quantum processors 1810 and quantum memory 1815. The quantum processing unit 1805 may reside in or be in communication with a cloud network 1820.

In an example embodiment, an optimization and personalization engine and a data aggregation module of a system for optimization and personalization of marketing actions using cloud, hybrid, and quantum-based computing techniques may reside on the quantum processing unit 1805. In further example embodiments, the operations of the optimization and personalization engine and the data aggregation module may be performed by the quantum processing unit 1805.

In a further example embodiment, the quantum processing unit 1805 may be in communication with one or more computer systems that may include at least one processor (e.g., a central processing unit, a graphics processing unit, and so on, singly or in combination), and a memory.

The example embodiments described herein can be implemented in an operating environment comprising computer-executable instructions installed on a computer, in software, in hardware, or in a combination of software and hardware.

Thus, systems and methods for optimization and personalization of marketing actions using cloud, hybrid, and quantum-based computing techniques have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for optimization and personalization of marketing actions using cloud, hybrid, and quantum-based computing techniques, the method comprising:
iteratively selecting, from a pool of prospective clients, at least one subgroup of the prospective clients based on predetermined criteria;
performing at least one marketing action on the at least one subgroup of the prospective clients;
in response to the at least one marketing action, receiving a feedback from a prospective client belonging to the at least one subgroup of the prospective clients;
scoring, by a machine learning technique, the feedback received from the prospective client; and
based on the scoring of the feedback, modifying the at least one marketing action until the at least one marketing action is optimized for the prospective client.

2. The method of claim 1, wherein the at least one marketing action is communicated to a user device associated with the prospective client, the user device being associated with one or more of the following techniques: artificial intelligence (AI), augmented reality (AR)/virtual reality (VR), rendering of three-dimensional (3D) objects and holograms via one or more communication networks, the one or more communication networks being associated with a telecommunication standard, the telecommunication standard including at least one of 5G and Internet of Things (IoT).

3. The method of claim 2, wherein the user device is a wearable device.

4. The method of claim 2, wherein the AR/VR provide one or more of the following features overlaid over physical objects: map directions, client assistance, visualization of marketing messages, promotions, real-time product recommendations, and real-time content recommendations.

5. The method of claim 1, wherein the at least one marketing action is part of a multi-sequential marketing scenario personalized for the prospective client.

6. The method of claim 1, wherein the at least one marketing action is optimized based on an evaluation of a state of mind of the prospective client.

7. The method of claim 1, wherein the at least one marketing action is optimized separately for each communication channel.

8. The method of claim 1, wherein the at least one marketing action is optimized based on personal data and environmental data associated with the prospective client.

9. The method of claim 8, wherein the environmental data include one or more of the following: weather, hydrometry, pollution, ultraviolet radiation, and a location.

10. The method of claim 8, wherein the personal data includes one or more of the following: a body type, a skin color, a weight, a height, an agenda, preferences, declarative information, historical purchase data, and historical behavior data.

11. The method of claim 1, wherein the prospective client is recognized using biometric recognition techniques.

12. The method of claim 1, wherein the at least one marketing action is optimized based on psychographic data, the psychographic data including one or more of the following: social pressures and personality influencing customer behavior, client maturity, preferences of family members associated with the prospective client, interests, hobbies, emotional triggers, lifestyles, activities, opinions, personality traits, a health condition, implied needs, expressed needs, nutrition, and habits.

13. The method of claim 12, wherein the psychographic data use a visual recognition to infer personality traits and assess sentiment.

14. A system for optimization and personalization of marketing actions using cloud, hybrid, and quantum-based computing techniques, the system comprising:
an optimization and personalization engine configured to:
iteratively select, from a pool of prospective clients, at least one subgroup of the prospective clients based on predetermined criteria;
perform at least one marketing action on the at least one subgroup of the prospective clients;
in response to the at least one marketing action, receive a feedback from a prospective client belonging to the at least one subgroup of the prospective clients; and
based on scoring of the feedback, modify the at least one marketing action until the at least one marketing action is optimized for the prospective client; and
a data aggregation module configured to:
score, by a machine learning technique, the feedback received from the prospective client.

15. The system of claim 14, wherein the at least one marketing action is communicated to a user device associated with the prospective client, the user device being associated with one or more of the following techniques: artificial intelligence (AI), augmented reality (AR)/virtual reality (VR), rendering of three-dimensional (3D) objects and holograms via one or more communication networks, the one or more communication networks being associated with a telecommunication standard, the telecommunication standard including at least one of 5G and Internet of things (IoT).

16. The system of claim 14, wherein the at least one marketing action is part of a multi-sequential marketing scenario personalized for the prospective client.

17. The system of claim 14, wherein the at least one marketing action is optimized separately per each communication channel.

18. The system of claim 14, wherein the at least one marketing action is optimized based on personal data and environmental data associated with the prospective client.

19. The system of claim 14, wherein the at least one marketing action is optimized based on psychographic data, the psychographic data including one or more of the following: social pressures and personality influencing customer behavior, client maturity, preferences of family members associated with the prospective client, interests, hobbies, emotional triggers, lifestyles, activities, opinions, personality traits, a health condition, implied needs, expressed needs, nutrition, and habits.

20. A system for optimization and personalization of marketing actions using cloud, hybrid, and quantum-based computing techniques, the system comprising:
an optimization and personalization engine configured to:
iteratively select, from a pool of prospective clients, at least one subgroup of the prospective clients based on predetermined criteria;
perform at least one marketing action on the at least one subgroup of the prospective clients;
in response to the at least one marketing action, receive a feedback from a prospective client belonging to the at least one subgroup of the prospective clients; and
based on scoring of the feedback, modify the at least one marketing action until the at least one marketing action is optimized for the prospective client, wherein the at least one marketing action is part of a multi-sequential marketing scenario personalized for the prospective client, wherein the at least one marketing action is optimized separately per each communication channel and based on at least one of the following:
personal data and environmental data associated with the prospective client;
an evaluation of a state of mind of the prospective client; and
psychographic data associated with the prospective client; and
a data aggregation module configured to:
score, by a machine learning technique, the feedback received from the prospective client.
